(19) United States
(12) Patent Application Publication
(10) Pub. No.: US 2016/0154812 A1
(43) Pub. Date: Jun. 2, 2016

(54) HYBRID DATABASE MANAGEMENT SYSTEM

(71) Applicant: Altibase Corp., Seoul (KR)

(72) Inventors: Hyung Sung Lee, Gyeonggi-do (KR); Kwang Ik Seo, Incheon (KR)

(21) Appl. No.: 14/637,613

(22) Filed: Mar. 4, 2015

(30) Foreign Application Priority Data
Dec. 2, 2014 (KR) 10-2014-0170740

(51) Int. Cl. G06F 17/30

(52) U.S. Cl. CPC G06F 17/30091; G06F 17/30946

(57) ABSTRACT

A hybrid database management system (DBMS) includes a data loading unit for loading data in a disk to a memory, and a random data loading unit for processing several data inquiry requests made by a user by using metadata information included in the hybrid DBMS, while data is being loaded from a disk to a memory. Even while data is sequentially being loaded by the data loading unit, data that has not been loaded yet to the data loading unit may be immediately used via a random data loading unit.

### RELATED APPLICATION

This application claims the benefit of Korean Patent Application No. 10-2014-0170740, filed on Dec. 2, 2014, in the Korean Intellectual Property Office, the disclosure of which is incorporated herein in its entirety by reference.

### BACKGROUND

1. Field

One or more exemplary embodiments relate to a database management system (DBMS), and more particularly, to a hybrid DBMS for supporting a function of immediately using data when the hybrid DBMS is started, even before all data is loaded to a memory.

2. Description of the Related Art

In a conventional in-memory database management system (DBMS), when the in-memory DBMS is started, a memory table and a memory index may be used after all data of the memory table and the memory index is loaded to a main memory unit. In this case, if an amount of data or a size of a memory index is large, it may be inconvenient to wait for a long period of time to use the memory table and the memory index after the in-memory-DBMS is started.

### SUMMARY

One or more exemplary embodiments include a method of solving such a problem that, when a conventional DBMS is started, it may be inconvenient to use data or data may not be used before the data is all loaded to a memory.

Additional aspects will be set forth in part in the description which follows and, in part, will be apparent from the description, or may be learned by practice of the presented embodiments.

According to one or more exemplary embodiments, a hybrid database management system (DBMS) includes: a data loading unit for loading data in a disk to a memory; a memory address mapping unit for generating a mapping table in the memory by mapping a page identification (ID) for identifying respective pages constituting a memory table and a memory index to a memory address of the respective pages, while the data in the disk is loaded to the memory; a random data loading unit for, when data is to be accessed before the mapping table is completed, searching for a memory address of the data to be accessed, with reference to the mapping table and, if the memory address is not found, calling the data to be accessed from the disk and loading the called data to the data loading unit, adding a memory address to which the called data is loaded, to the mapping table, and mapping the added memory address to a page ID to which the called data belongs.

Data in the memory table and the memory index may be accessible via the random data loading unit, before the data in the memory table and the memory index is loaded to the memory.

The memory address mapping unit may map a page ID to a starting memory address of a page in the mapping table to which loading of data is complete.

The record access unit may detect the starting memory address of the page in the mapping table by using page ID information from among RID information, and a memory address of a particular record in a particular page from among the respective pages by using the detected starting memory address and offset information from among the RID information, wherein the RID information includes the page ID information and the offset information.

### BRIEF DESCRIPTION OF THE DRAWINGS

These and/or other aspects will become apparent and more readily appreciated from the following description of the embodiments, taken in conjunction with the accompanying drawings in which:

FIG. 1 is an internal block diagram of a hybrid database management system (DBMS) according to an exemplary embodiment;

FIG. 2 illustrates an embodiment of loading data in a disk to a memory in the hybrid DBMS, according to an exemplary embodiment;

FIG. 3 illustrates an embodiment of a mapping table used in the hybrid DBMS, according to an exemplary embodiment;

FIG. 4 illustrates an example of metadata information included in the hybrid DBMS according to an exemplary embodiment;

FIG. 5 illustrates an example of work that may be selectively performed, if a memory index in the hybrid DMBS manages a memory address of respective records in a memory table, according to an exemplary embodiment; and

FIG. 6 is a flowchart of immediately using all memory tables and memory indexes when the hybrid DBMS is started, according to an exemplary embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of”, when preceding a list of elements, modify the entire list of elements and do not modify the individual elements of the list.

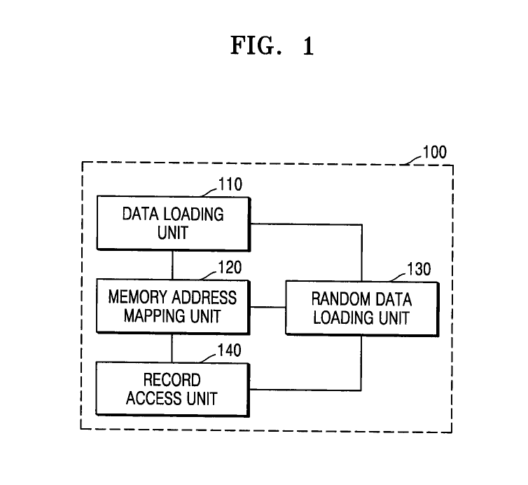

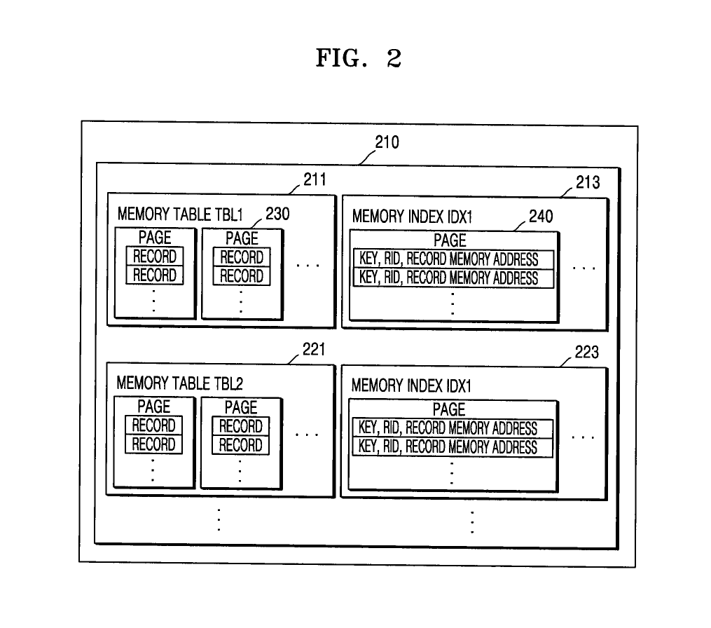

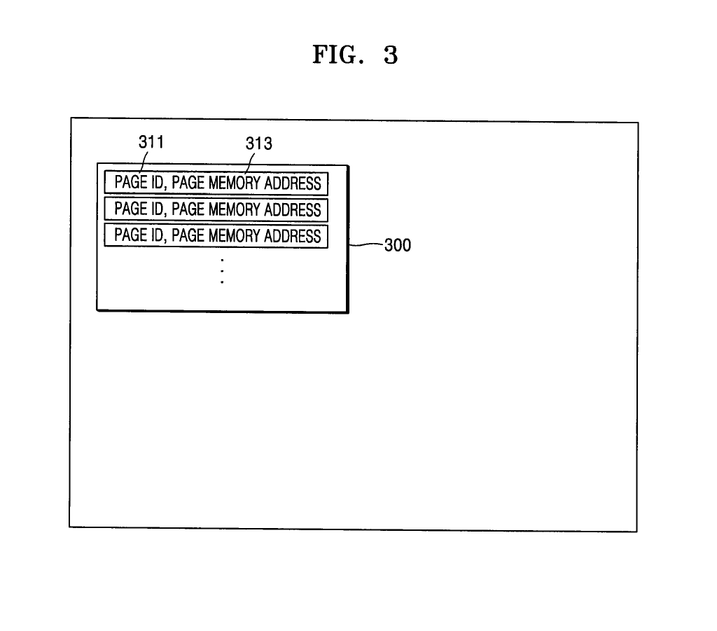

FIG. 1 is an internal block diagram of a hybrid database management system (DBMS) 100 according to an exemplary embodiment. FIG. 2 illustrates an embodiment of loading data in a disk to a memory in the hybrid DBMS 100, according to an exemplary embodiment. FIG. 3 illustrates an embodiment of a mapping table used in the hybrid DBMS 100, according to an exemplary embodiment.

Referring to FIGS. 1 through 3, an internal configuration of the hybrid DBMS 100 is described as follows.

According to an exemplary embodiment of the hybrid DBMS 100, when the hybrid DBMS 100 is started, memory tables and memory indexes may be used even before all data in the memory tables and the memory indexes is loaded to a main memory unit such as the memory.

The hybrid DBMS 100 includes a data loading unit 110, a memory address mapping unit 120, a random data loading unit 130, and a record access unit 140.

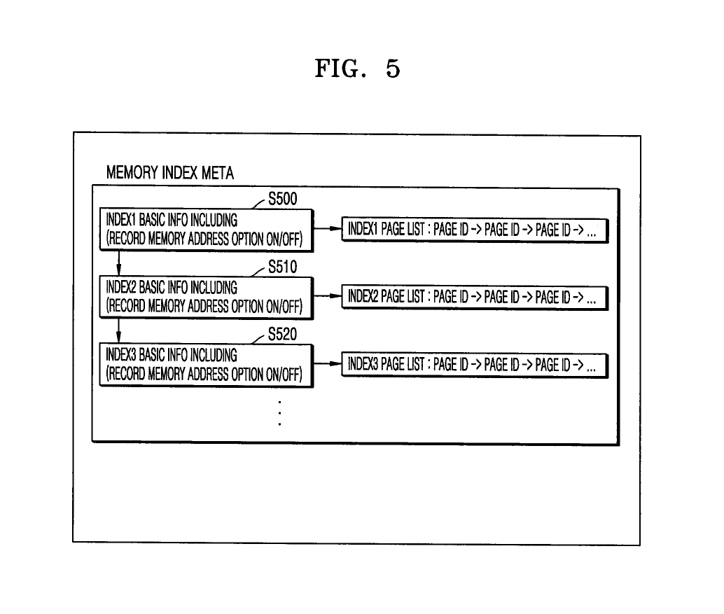

If the hybrid DBMS 100 is started, the data loading unit 110 starts to load all data in memory tables 211 and 221 and memory indexes 213 and 223 to the memory. The data loading unit 110 may be operated just once when the hybrid DBMS 100 is started. All the data in the memory tables 211 and 221 and in the memory indexes 213 and 223 is formed in the units of pages 230 and 240. The memory indexes 213 and 223 manage a row identifier (RID) of respective records in the memory tables 211 and 221. Additionally, the memory indexes 213 and 223 may selectively manage a memory address of the respective records in the memory tables 211 and 221. When respective memory indexes are defined, it may be selected whether to manage a memory address of each record in S500, S510, and S520 shown in FIG. 5.

If data 0001 through data 3000 is to be moved from the disk to the memory, the data loading unit 110 may sequentially split the data 0001 through the data 3000 into data 0001 through data 1000, data 1001 through data 2000, and data 2001 through data 3000 and move the split data 0001 through data 3000 in parallel to the memory.

The data loading unit 110 loads all data in the units of pages, and accesses the loaded data with reference to a mapping table 300 shown in FIG. 3. The data loaded to the data loading unit 110 may be present in the memory until the hybrid DBMS 100 is ended.

While the data loading unit 110 shown in FIG. 1 is loading data in the disk to the memory, the memory address mapping unit 120 generates the mapping table 300, shown in an embodiment described with reference to FIG. 3, in the memory by mapping a page identification (ID) for identifying a respective page constituting memory tables (211 and 221) and memory indexes (213 and 223) to a memory address of the respective pages.

When the hybrid DBMS 100, shown in FIG. 1, is started, the mapping table 300 includes only information about a page ID 311, and a memory address 313 corresponding to the page ID 311 is empty. Referring to FIG. 3, the memory address mapping unit 120 completes the mapping table 300 by performing a process of writing the memory address 313, determined when the data loading unit 110 loads data to the memory, to a location of the page ID 311 corresponding to the memory address 313. In this case, a starting memory address of a page corresponding to the page ID 311 may be used as the memory address 313.

According to an exemplary embodiment, while generating the mapping table 300 by using the memory address 313 that is determined when the data loading unit 110 loads data to the memory, the memory address mapping unit 120 may further use a memory address determined by the random data loading unit 130.

Before the data loading unit 110 loads all data to the memory, the memory address mapping unit 120 sequentially completes the mapping table 300 by using the memory address 313 that is determined when the data loading unit 110 loads data to the memory. In this process, if a user requests access to particular data, the random data loading unit 130 may determine a memory address of the particular data, and add the memory address to the mapping table 300.

If a user is to access a memory table or a memory index to execute a structured query language (SQL) sentence, even if data in the memory table and the memory index in the hybrid DBMS 100 is not all loaded to the memory, the data may be directly used in the hybrid DBMS 100 via the random data loading unit 130. The random data loading unit 130 may be called for several times upon a request by the user, until before the mapping table 300 shown in FIG. 3 is completed.

In this case, the random data loading unit 130 may access data by using a page ID or RID information that is managed by the memory index.

If the random data loading unit 130 is to access data before the mapping table 300 shown in FIG. 3 is completed, the random data loading unit 130 searches for a memory address of the data to be accessed, with reference to the mapping table 300 shown in FIG. 3.

If the memory address of the data to be accessed is not found in the mapping table 300 shown in FIG. 3, the random data loading unit 130 calls the data to be accessed from a disk, load the called data to the data loading unit 110 shown in FIG. 1, add a memory address, to which the called data is loaded, to the mapping table 300 shown in FIG. 3, and then, map the added memory address to a page ID corresponding to the called data.

According to an exemplary embodiment, the hybrid DBMS 100 shown in FIG. 1 may determine a memory address of a particular record in a particular page via the record access unit 140.

The record access unit 140 accesses a particular record in a particular page by using RID information indicating a logical address of data. The RID information consists of page ID information and offset information. According to an exemplary embodiment, the record access unit 140 detects a starting memory address of the particular page in the mapping table by using the page ID information from among the RID information, and determines a memory address of the particular record by using the detected starting memory address and the offset information from among the RID information. The record access unit 140 accesses the particular record by using the determined memory address of the particular record. The determined memory address of the particular record is written to a memory index, if the memory index is defined as to manage a memory address of each record in the index.

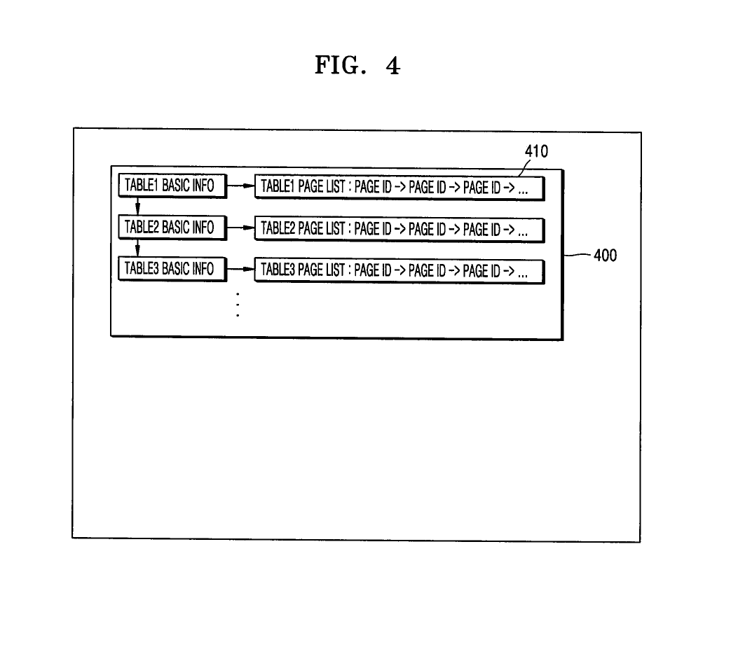

FIG. 4 illustrates an example of metadata information included in the hybrid DBMS 100 shown in FIG. 1 according to an exemplary embodiment.

The hybrid DBMS 100 shown in FIG. 1 includes metadata information 400 shown in FIG. 4, and includes page ID list information in each table as metadata information 410.

According to an exemplary embodiment, the memory address mapping unit 120 and the random data loading unit 130, shown in FIG. 1, may obtain table information, page list information, and page ID information of data to be loaded or accessed, with reference to the metadata information 400 shown in FIG. 4.

FIG. 5 illustrates an example of work that may be selectively performed, if a memory index in the hybrid DMBS 100 manages a memory address of respective records in a memory table, according to an exemplary embodiment.

If all data is loaded from a disk to a memory via the data loading unit 110 shown in FIG. 1 included in the hybrid DBMS 100, a mapping table is completed by the memory address mapping unit 120 shown in FIG. 1.

After the mapping table is complete, page ID information and offset information are figured out by using RID information of each record with respect to all records written in the memory index. Then, a starting address of a memory corresponding to a page ID in the mapping table is determined, and offset information is added to the starting address of the memory, and thus, a memory address of a particular record may be determined. A determined memory address of each record is written to the memory index.

In other words, the memory index may manage RID information of each record in the memory table, and may provide a user with an interface to select whether to separately manage a memory address of each record in the memory table in S500, S510, and S520.

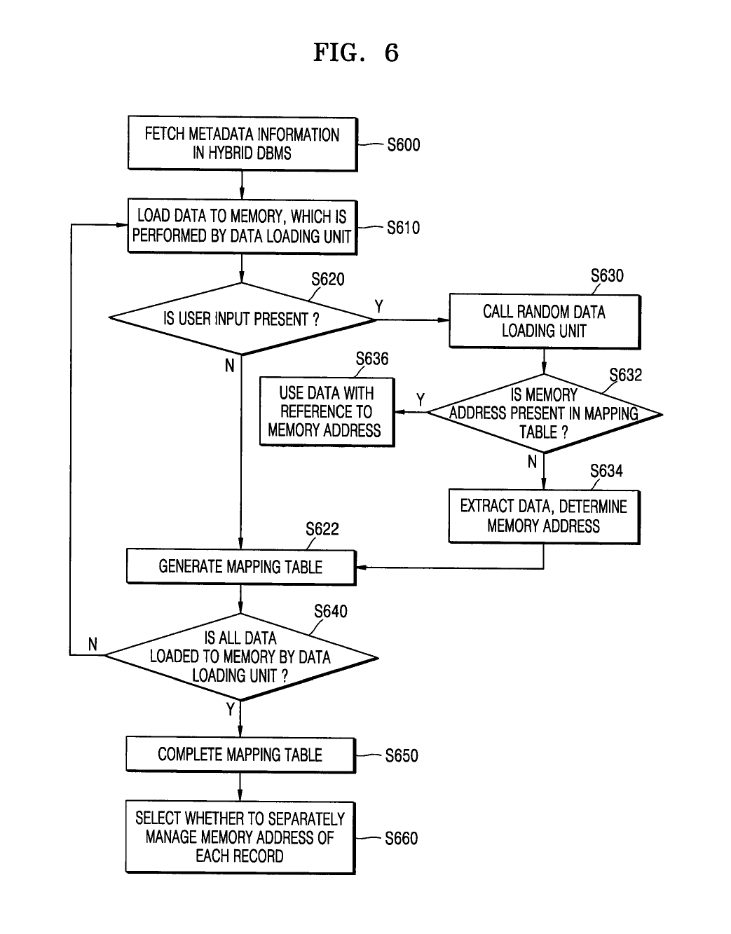

FIG. 6 is a flowchart of immediately using all memory tables and memory indexes when a hybrid DBMS is started, according to an exemplary embodiment.

When a hybrid DBMS is started, a data loading unit fetches metadata information in the hybrid DBMS in operation S600 so as to figure out page ID information, and starts to load data in a disk to a memory in operation S610.

While the data loading unit loads the data in the disk to the memory, if a user input is present in operation S620, the random data loading unit is called in operation S630. If the random data loading unit checks that a memory address of data requested by a user is present in the mapping table in operation S632, the random data loading unit uses data with reference to the memory address in the mapping table in operation S636. However, if a memory address of the data requested by the user is not present in the mapping table, the random data loading unit accesses the disk, and loads from a disk page to a memory page and figures out the memory address of the loaded memory page so as to generate a mapping table in operation S622.

The data loading unit loads data to the memory only once, when the hybrid DBMS is started. However, the random data loading unit is implemented to be called for several times while the data loading unit loads data to the memory, so as to immediately use data requested by the user.

If the data loading unit loads all data to the memory S640, the mapping table is completed in operation S650. Then, the data loading unit may support an interface via which it may be selected whether to manage a memory address of respective records in the memory index in operation S660.

As described above, according to the one or more of the above exemplary embodiments, data in a hybrid DBMS may be immediately used even before all data in a memory table and a memory index in the hybrid DBMS is loaded to the memory.

In addition, other embodiments can also be implemented through computer-readable code/instructions in/on a medium, e.g., a computer-readable medium, to control at least one processing element to implement any above-described embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer-readable code is loaded/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A hybrid database management system (DBMS) comprising:
a data loading unit for loading data in a disk to a memory;
a memory address mapping unit for generating a mapping table in the memory by mapping a page identification (ID) for identifying respective pages constituting a memory table and a memory index to a memory address of the respective pages, while the data in the disk is loaded to the memory; and
a random data loading unit for, when data is to be accessed before the mapping table is completed, searching for a memory address of the data to be accessed, with reference to the mapping table and, if the memory address is not found, calling the data to be accessed from the disk and loading the called data to the data loading unit, adding a memory address to which the called data is loaded, to the mapping table, and mapping the added memory address to a page ID to which the called data belongs.

2. The hybrid DBMS of claim 1, wherein data in the memory table and the memory index are accessible via the random data loading unit, before the data in the memory table and the memory index is loaded to the memory.

3. The hybrid DBMS of claim 1, wherein the memory address mapping unit maps a page ID to a starting memory address of a page in the mapping table to which loading of data is complete.

4. The hybrid DBMS of claim 1, further comprising a record access unit for accessing a particular record in a particular page from among the respective pages.

5. The hybrid DBMS of claim 4, wherein the record access unit accesses the particular record in the particular page by using row identifier (RID) information indicating a logical address of data.

6. The hybrid DBMS of claim 5, wherein the memory index manages RID information of each record in the memory table and is configured to select whether to manage a memory address of each record in the memory table separately or not.

7. The hybrid DBMS of claim 3, wherein the record access unit detects the starting memory address of the page in the mapping table by using page ID information from among RID information, and detects a memory address of a particular record in a particular page from among the respective pages by using the detected starting memory address and offset information from among the RID information, wherein the RID information comprises the page ID information and the offset information.

8. The hybrid DBMS of claim 1, wherein the random data loading unit is started according to at least one DBMS user session request and, according to the at least one DBMS user session request, synchronously or asynchronously accesses data corresponding to the at least one DBMS user session request.

9. The hybrid DBMS of claim 1, wherein the random data loading unit is started only while the data loading unit is loading the data in the disk to the memory in the units of pages.

10. The hybrid DBMS of claim 1, wherein the random data loading unit further comprises an input unit for receiving at least one DBMS user session request, and is started according to the at least one DBMS user session request.

11. The hybrid DBMS of claim 1, wherein the data loading unit loads data in all memory tables and all memory indexes to the memory when a DBMS is started.

12. The hybrid DBMS of claim 11, wherein the data loading unit divides the data in the disk and loads the data to the memory in parallel when a hybrid DBMS is started.
